(19) United States
(12) Patent Application Publication
(10) Pub. No.: US 2013/0055913 A1
(43) Pub. Date: Mar. 7, 2013

(54) PLATE CYLINDER

(71) Applicants: Ingvar Andersson, Loddekopinge (SE); Thomas Pettersson, Stockamollan (SE); Ola Rehnström, Malmo (SE); Peter Öhman, Lund (SE)

(72) Inventors: Ingvar Andersson, Loddekopinge (SE); Thomas Pettersson, Stockamollan (SE); Ola Rehnström, Malmo (SE); Peter Öhman, Lund (SE)

(21) Appl. No.: 13/696,748

(22) PCT Filed: Apr. 29, 2010
(86) PCT No.: PCT/SE2011/050530

§ 371 Date: Nov. 7, 2012

(30) Foreign Application Priority Data
May 7, 2010 (SE) 1000470-3

(51) Int. Cl. B41F 13/10

(52) U.S. Cl. 101/375

(57) ABSTRACT

A plate cylinder includes a rotational shaft and at least one printing plate configured to be attached to the shaft. The rotational shaft may include an inner cylindrical body being made of a first material, an intermediate sleeve being made of a second material, and an outer sleeve being made of a third material. The Young's modulus of the second material may be substantially less than the Young's modulus of the first and third material.

### TECHNICAL FIELD

The invention relates to the field of rollers used in the printing industry. More particularly, the invention relates to a plate cylinder for flexographic printing presses.

### BACKGROUND OF THE INVENTION

Flexographic printing is used for a number of different printing applications. The technique uses a printing plate having a topographic pattern corresponding to a reflection of the image to be printed, and the printing plate is mounted on a plate cylinder. Ink is provided to the printing plate, and the ink is then transferred to a continuous web that is being fed through a press nip formed by the plate cylinder and an impression cylinder. A flexographic printing press may operate at a speed up to 1000 m/min.

In a common configuration, a number of printing plates are mounted on the plate cylinder as segments. For example, ten segments may be arranged in a staggered way to cover the complete surface area of the plate cylinder. This means that the printing plates will induce periodical impression forces on the impression cylinder.

The complete printing press is a complex construction of many interconnected and moving parts. As with most mechanical systems, vibrations may build up and propagate within the system. When such vibrations are introduced close to a resonance frequency of a printing press, the amplitude of the vibrations is increased and may cause defects in the printed images, as well as wear on movable parts of the system. This effect is from hereon called bouncing, and depends on the sum of all frequencies of the system such as rotational speeds of the cylinders, as well as the periodical impression forces caused by the patterned printing plates.

The bouncing of the plate cylinder may cause defects on the printed image in either one of two ways; by the fact that the plate cylinder looses contact with the anilox cylinder, i.e. the cylinder providing ink to the plate cylinder, or by the fact that the plate cylinder looses contact with the web to be printed.

As the printing process relies on the periodical impact of topographic protrusions of the printing plate on an impression cylinder, there is a big probability that the bouncing will occur at a specific point during acceleration or deceleration of the system. This is due to the fact that the frequency of the impact force from the topographic protrusions of the printing plate will increase with line speed. Consequently, when the frequency of the impact force is equal to the mandrels response frequency bouncing will occur.

The printing plates may be fastened to the plate cylinder by means of disposable adhesive tape, which has three functions; to securely attach the printing plates, to compensate for intrinsic thickness variations of the printing plate, and to damp the impact on the impression cylinder.

A typical quantity of ordered printed material is 25.000 to 30.000 m. An operating speed of 600 m/min results in a change of printing plates every hour. Hence, a large quantity of adhesive tape will be used for dampening the periodical impact, and an effort in improving the damping of the impact would result in an increase of tape thickness involving high costs and significant amount of work during change of printing plates.

### SUMMARY

It is, therefore, an object of the present invention to overcome or alleviate the above-described problems.

A further object of the present invention is to provide a plate cylinder for increasing the printing quality of a flexographic printing press by reducing or even eliminating bouncing.

According to a first aspect of the present invention, a plate cylinder is provided. The plate cylinder comprises a rotational shaft having means for attaching at least one printing plate to said shaft, said rotational shaft having an inner cylindrical body being made of a first material, an intermediate sleeve being made of a second material, and an outer sleeve being made of a third material, wherein the Young's modulus of said second material is substantially less than the Young's modulus of said first and third material.

The first material may be the same as the third material, which is advantageous in that the plate cylinder may be manufactured by a less complex process, involving a less number of raw materials.

The Young's modulus of said first and third material may be larger than 50000 N/mm², and the Young's modulus of said second material may be smaller than 10000 N/mm². Hence, the plate cylinder will have a sufficient outer rigidity while still allowing for reduced, or even eliminated bouncing.

The intermediate sleeve may extend over the complete length of the rotational shaft which is advantageous in that the effect of reduced bouncing is provided for all printing plates along the length of the plate cylinder.

The distance between the intermediate sleeve and the outer surface of the rotational shaft may be less than the distance between the intermediate sleeve and the rotational axis of said rotational shaft. Hence, the thickness of the intermediate sleeve may be made thinner while still providing reduced bouncing.

The printing plate may be a flexographic printing plate.

According to a second aspect of the invention, a printing press is provided comprising at least one plate cylinder according to the first aspect of the invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 is a schematic view of a plate cylinder setup in a printing press;

FIG. 2 is a diagram showing bouncing as a function of press speed;

FIG. 3a is a cross-sectional view of a plate cylinder according to an embodiment;

FIG. 4a is a top view of a printing plate arrangement; and

FIG. 4b is a perspective view of a plate cylinder including the printing plate arrangement of FIG. 4a.

### DETAILED DESCRIPTION OF PREFERRED EMBODIMENTS

With reference to FIG. 1, an ink-providing station of a flexographic printing press is shown schematically. A web 2 of paper material, such a carton web, is fed through a press nip formed by a plate cylinder 4 rotating against an impression roller 6. Ink is supplied to the plate cylinder 4 from an ink providing unit 12 via an anilox cylinder 8, which rotates against the plate cylinder 4. Printing plates 10, having a topographic pattern corresponding to the image to be printed, are arranged on the outer surface of the plate cylinder 4 such that the ink only adheres to the protrusive portions of the printing plates 10. When a printing plate 10 is in contact with the web 2, the ink is transferred to the web 2 such that an image is created.

A flexographic printing press typically has a plurality of ink-providing stations, such that each ink-providing part is responsible for a given color. For example, a flexographic printing press may have four ink-providing stations for cyan, magenta, yellow, and black. Additional stations may also be provided for providing ink of a specific color that may not be correctly created by blending already existing colors.

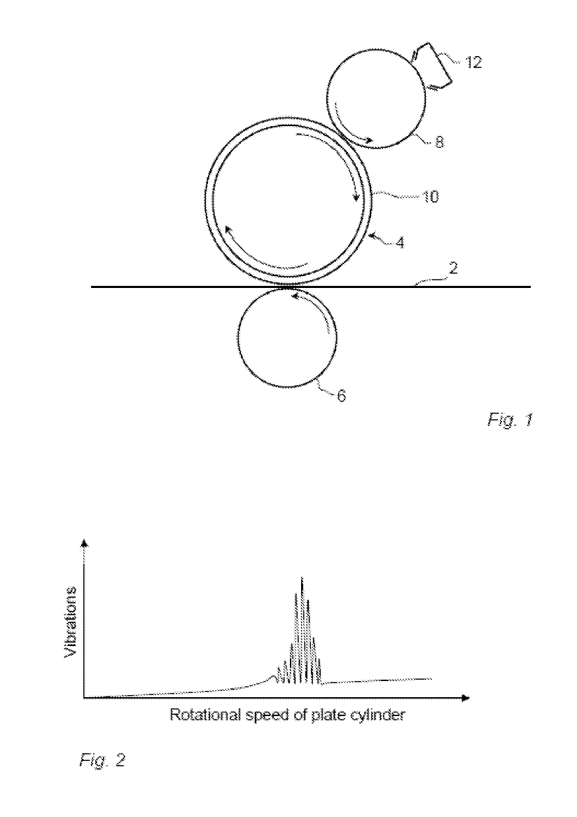

When the printing press is operating, vibrations are induced and propagating through the printing press. The rotating speed of the rollers as well as the topographical pattern of the printing plates all contribute to an overall frequency distribution that is schematically shown in FIG. 2 as a function of the rotating speed of the plate cylinder.

When the speed is increased at start-up, vibrations are induced in the printing press. At a specific press speed, resonance is occurring such that the amplitude of the vibrations is increased to create bouncing. As the speed further increases, the resonance is lost and the bouncing disappears. However, the web being fed through the press nip during the resonance interval has a lower printing quality and may not be used to form a finished product, such as a packaging laminate for a liquid food package.

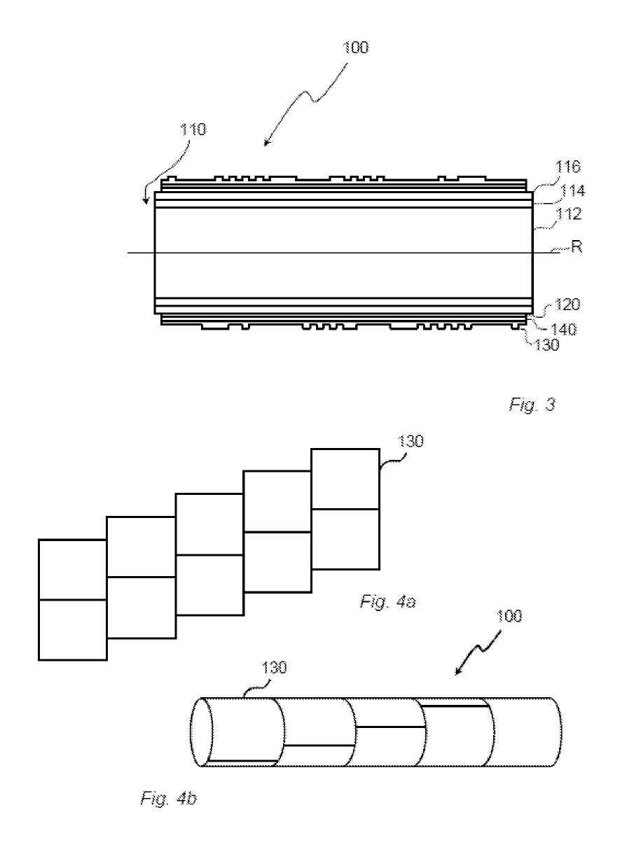

A plate cylinder 100 is shown in FIG. 3, configured to reduce or eliminate the effect of bouncing. The plate cylinder 100 may replace the plate cylinder 4 shown in FIG. 1.

The plate cylinder 100 comprises a rotational shaft 110 having a rotational axis R around which the rotational shaft rotates during operation. The rotational shaft 110 has an inner cylindrical body 112 made of a first material, and an intermediate sleeve 114 that surrounds and encloses the inner cylindrical body 112. The intermediate sleeve 114 is made of a second material. An outer sleeve 116 made of a third material is arranged outside the intermediate sleeve 114 such that the outer sleeve 116 encloses and surrounds the intermediate sleeve 114.

A further sleeve 120 is arranged on the rotational shaft 110 and printing plates 130 are attached to the sleeve 120 by means of adhesive tape 140. The sleeve 120 is fitted tightly to the outer surface of the rotational shaft 110. To achieve a simple mounting and demounting of the sleeve 120, the outer surface of the outer sleeve 116 is provided with a plurality of holes for supplying pressurized air. Hence, pressurized air is provided when the sleeve 120 is to be mounted or demounted, such that the sleeve 120 may be slid on the rotational shaft 110 with low friction. In alternative embodiments the sleeve 120 and/or the printing plate 130 may comprise a suitable adhesive.

The material of the inner cylindrical body 112 may be identical to the material of the outer sleeve 116. In one embodiment, the material of the inner cylindrical body 112 and the outer sleeve 116 may be steel having a Young's modulus of approximately 210000 N/mm². In another embodiment, the material of the inner cylindrical body 112 and the outer sleeve 116 may be carbon fiber having a Young's modulus of approximately 150000 N/mm².

The second material, i.e. the material of the intermediate sleeve 114, may be an elastic material having a Young's modulus of 10 to 1000 N/mm². Such material may for example be rubber or any polymeric material known per se. In a preferred embodiment, the material of the intermediate sleeve 114 is a composite structure having a nominal density of 35 to 100 kg/m³, and at room temperature a compressive strength of 0.4 to 100 MPa, a compressive modulus of 40 to 150 MPa, a tensile strength of 1 to 3.5 MPa, a tensile modulus of 50 to 130 MPa, a shear strength of 0.4 to 1.6 MPa, a shear modulus of 10 to 35, and a shear strain of 10 to 40%.

The intermediate sleeve 114 is preferably arranged close to the outer surface of the rotational shaft 110, such that the distance between the intermediate sleeve 114 and the outer surface of the rotational shaft is substantially smaller than the distance between the intermediate sleeve 114 and the center of the rotational shaft 110. The outer sleeve 116 provides a rigid surface onto which the further sleeve 120 and the printing plates 130 may be attached. The intermediate sleeve 114 may be made thinner as it is arranged close to the outer surface of the rotational shaft 110. This is due to the fact that the elastic contribution will be reduced by the rigidity of the outer sleeve 116.

The printing plates 130 and the adhesive tape 140 are disposable consumables, which are only used one time. The rotational shaft 110 may be a permanent part of the printing press.

An arrangement of printing plates is shown in FIGS. 4a and 4b, where ten printing plates 130 are arranged in a staggered pattern. The length of two adjacent printing plates 130 corresponds to the diameter of the plate cylinder, while the width of five adjacent printing plates corresponds to the length of the plate cylinder 100. The staggered arrangement affect the contribution to bouncing.

When a plate cylinder 100 is arranged in a flexographic printing press, the intermediate sleeve 114 of elastic material will reduce the amplitude of the impact of the periodical pattern of the printing plates onto the impression cylinder. Therefore, the resonance may be greatly reduced such that bouncing is avoided.

The invention has mainly been described above with reference to a few embodiments. However, as is readily appreciated by a person skilled in the art, other embodiments than the ones disclosed above are equally possible within the scope of the invention, as defined by the appended patent claims.

1. A plate cylinder, comprising:
a rotational shaft; and
at least one printing plate configured to be attached to said shaft,
wherein said rotational shaft has an inner cylindrical body being made of a first material, an intermediate sleeve being made of a second material, and an outer sleeve being made of a third material,
wherein the Young's modulus of said second material is substantially less than the Young's modulus of said first and third material.

2. The plate cylinder according to claim 1, wherein said first material is the same as said third material.

3. The plate cylinder according to claim 1, wherein the Young's modulus of said first and third material is larger than 50000 N/mm², and wherein the Young's modulus of said second material is smaller than 10000 N/mm².

4. The plate cylinder according to claim 1, wherein the intermediate sleeve extends over the complete length of the rotational shaft.

5. The plate cylinder according to claim 1, wherein the distance between the intermediate sleeve and the outer surface of the rotational shaft is less than the distance between the intermediate sleeve and the rotational axis of said rotational shaft.

6. The plate cylinder according to claim 1, wherein said printing plate is a flexographic printing plate.

7. A printing press, comprising at least one plate cylinder according to claim 1.
